(19) United States
(12) Patent Application Publication
(10) Pub. No.: US 2025/0200337 A1
(43) Pub. Date: Jun. 19, 2025

(54) Method, System, and Computer Program Product for Simplifying Transformer for Sequential Recommendation

(71) Applicant: VISA INTERNATIONAL SERVICE ASSOCIATION, San Francisco, CA (US)

(72) Inventors: Huiyuan Chen, San Jose, CA (US); Xiaoting Li, Sunnyvale, CA (US); Menghai Pan, San Jose, CA (US); Hao Yang, San Jose, CA (US); Michael Yeh, Newark, CA (US)

(21) Appl. No.: 18/845,664

(22) PCT Filed: May 30, 2023
(86) PCT No.: PCT/US23/23853

§ 371 Date: Sep. 10, 2024

Related U.S. Application Data
(60) Provisional application No. 63/347,166, filed on May 31, 2022.

(51) Int. Cl. G06N 3/0455; G06N 3/048

(52) U.S. Cl. CPC G06N 3/0455; G06N 3/048

(57) ABSTRACT

Methods, systems, and computer program products may simplify Transformer machine learning models for sequential recommendation via a softmax-free gated attention mechanism and/or may use a gated unit to further sparsify attentions, which may simplify attention distributions and reduce negative impacts of noisy items.

### CROSS-REFERENCE TO RELATED APPLICATIONS

This application is the United States national phase of International Patent Application No. PCT/US23/23853 filed May 30, 2023, and claims the benefit of U.S. Provisional Application No. 63/347,166, filed May 31, 2022, the disclosures of which are hereby incorporated by reference in their entireties.

### BACKGROUND

### 1. Technical Field

This disclosure relates to Transformer machine learning models and, in some non-limiting embodiments or aspects, to methods, systems, and computer program products for simplifying Transformer machine learning models for sequential recommendation via a softmax-free gated attention mechanism.

### 2. Technical Considerations

Transformer is a deep learning model that adopts the mechanism of self-attention, differentially weighting the significance of each part of the input data.

### SUMMARY

Accordingly, provided are improved systems, devices, products, apparatus, and/or methods for simplifying Transformer for sequential recommendation. For example, non-limiting embodiments or aspects may address weaknesses in Transformers in handling noisy sequences. As an example, non-limiting embodiments or aspects may use a gated attention layer, which enables the use of a weaker single-head attention with minimal quality loss and/or a probabilistic sparsification framework that can further prune noise and achieve sparse attention in high quality.

According to some non-limiting embodiments or aspects, provided is a method, including: receiving an input sequence having a respective input at each of a plurality of input positions in an input order; processing the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; processing the encoded representations through a decoder neural network to generate an output sequence having a respective output at each of a plurality of output positions in an output order; and providing the output sequence having the respective output at each of the plurality of output positions in the output order.

In some non-limiting embodiments or aspects, the shared representation is determined by applying a trainable variable to the encoder subnetwork inputs at the plurality of input positions.

In some non-limiting embodiments or aspects, the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

In some non-limiting embodiments or aspects, the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

In some non-limiting embodiments or aspects, the gated attention layer generates the respective output for the particular input position by applying a rectified linear unit (ReLU) activation function to the respective attention value for the particular input position and the values for the plurality of input positions.

In some non-limiting embodiments or aspects, each encoder subnetwork is trained according to an objective function that depends on the learned variance and a desired attention capacity.

According to some non-limiting embodiments or aspects, provided is a system including one or more computers and one or more storage devices storing instructions that when executed by the one or more computers cause the one or more computers to implement a sequence transduction neural network for transducing an input sequence having a respective network input at each of a plurality of input positions in an input order into an output sequence having a respective network output at each of a plurality of output positions in an output order, the sequence transduction neural network including: an encoder neural network configured to receive the input sequence and generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; and a decoder neural network configured to receive the encoded representations and generate the output sequence.

In some non-limiting embodiments or aspects, the shared representation is determined by applying a trainable variable to the encoder subnetwork inputs at the plurality of input positions.

In some non-limiting embodiments or aspects, the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

In some non-limiting embodiments or aspects, the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

In some non-limiting embodiments or aspects, the gated attention layer generates the respective output for the particular input position by applying a rectified linear unit (ReLU) activation function to the respective attention value for the particular input position and the values for the plurality of input positions.

In some non-limiting embodiments or aspects, each encoder subnetwork is trained according to an objective function that depends on the learned variance and a desired attention capacity.

According to some non-limiting embodiments or aspects, provided is a computer program product including a non-transitory computer readable medium including program instructions which, when executed by at least one processor, cause the at least one processor to: receive an input sequence having a respective input at each of a plurality of input positions in an input order; process the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; process the encoded representations through a decoder neural network to generate an output sequence having a respective output at each of a plurality of output positions in an output order; and provide the output sequence having the respective output at each of the plurality of output positions in the output order.

In some non-limiting embodiments or aspects, the shared representation is determined by applying a trainable variable to the encoder subnetwork inputs at the plurality of input positions.

In some non-limiting embodiments or aspects, the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

In some non-limiting embodiments or aspects, the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

In some non-limiting embodiments or aspects, the gated attention layer generates the respective output for the particular input position by applying a rectified linear unit (ReLU) activation function to the respective attention value for the particular input position and the values for the plurality of input positions.

In some non-limiting embodiments or aspects, each encoder subnetwork is trained according to an objective function that depends on the learned variance and a desired attention capacity.

Further non-limiting embodiments or aspects are set forth in the following numbered clauses:

Clause 1. A method, comprising: receiving an input sequence having a respective input at each of a plurality of input positions in an input order; processing the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; processing the encoded representations through a decoder neural network to generate an output sequence having a respective output at each of a plurality of output positions in an output order; and providing the output sequence having the respective output at each of the plurality of output positions in the output order.

Clause 2. The method of clause 1, wherein the shared representation is determined by applying a trainable variable to the encoder subnetwork inputs at the plurality of input positions.

Clause 3. The method of clauses 1 or 2, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

Clause 4. The method of any of clauses 1-3, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

Clause 5. The method of any of clauses 1-4, wherein the gated attention layer generates the respective output for the particular input position by applying a rectified linear unit (ReLU) activation function to the respective attention value for the particular input position and the values for the plurality of input positions.

Clause 6. The method of any of clauses 1-5, wherein each encoder subnetwork is trained according to an objective function that depends on the learned variance and a desired attention capacity.

Clause 7. A system comprising one or more computers and one or more storage devices storing instructions that when executed by the one or more computers cause the one or more computers to implement a sequence transduction neural network for transducing an input sequence having a respective network input at each of a plurality of input positions in an input order into an output sequence having a respective network output at each of a plurality of output positions in an output order, the sequence transduction neural network comprising: an encoder neural network configured to receive the input sequence and generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; and a decoder neural network configured to receive the encoded representations and generate the output sequence.

Clause 8. The system of clause 7, wherein the shared representation is determined by applying a trainable variable to the encoder subnetwork inputs at the plurality of input positions.

Clause 9. The system of clauses 7 or 8, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

Clause 10. The system of any of clauses 7-9, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

Clause 11. The system of any of clauses 7-10, wherein the gated attention layer generates the respective output for the particular input position by applying a rectified linear unit (ReLU) activation function to the respective attention value for the particular input position and the values for the plurality of input positions.

Clause 12. The system of any of clauses 7-11, wherein each encoder subnetwork is trained according to an objective function that depends on the learned variance and a desired attention capacity.

Clause 13. A computer program product including a non-transitory computer readable medium including program instructions which, when executed by at least one processor, cause the at least one processor to: receive an input sequence having a respective input at each of a plurality of input positions in an input order; process the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; process the encoded representations through a decoder neural network to generate an output sequence having a respective output at each of a plurality of output positions in an output order; and provide the output sequence having the respective output at each of the plurality of output positions in the output order.

Clause 14. The computer program product of clause 13, wherein the shared representation is determined by applying a trainable variable to the encoder subnetwork inputs at the plurality of input positions.

Clause 15. The computer program product of clauses 13 or 14, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

Clause 16. The computer program product of any of clauses 13-15, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

Clause 17. The computer program product of any of clauses 13-16, wherein the gated attention layer generates the respective output for the particular input position by applying a rectified linear unit (ReLU) activation function to the respective attention value for the particular input position and the values for the plurality of input positions.

Clause 18. The computer program product of any of clauses 13-17, wherein each encoder subnetwork is trained according to an objective function that depends on the learned variance and a desired attention capacity.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS AND APPENDICES

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for simplifying Transformer for sequential recommendation;

FIG. 4A is a diagram of a model architecture of non-limiting embodiments or aspects of a Transformer;

FIG. 4B is a diagram of a model architecture of non-limiting embodiments or aspects of a Gated Attention Network (GAN);

FIG. 5 is a table of data statistics for an example experiment;

FIG. 6 is a table of performance results for an example experiment; and

FIG. 7 is a diagram of a model architecture of an existing Transformer.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the terms “request,” “response,” “request message,” and “response message” may refer to one or more messages, data packets, signals, and/or data structures used to communicate data between two or more components or units.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Sequential recommendation aims to recommend a next item based on a user's historical actions (e.g., to recommend a Bluetooth® headphone after a user purchases a smart phone, etc.), which has received great attention in recommender systems. Learning sequential user behaviors may, however, be challenging because a user's choices on items generally depend on both long-term and short-term preferences. Early Markov Chain models have been proposed to capture short-term item transitions by assuming that a user's next decision is derived from the preceding few actions, but neglecting long-term preferences. To alleviate this issue, many deep neural networks have achieved great success on modeling entire users' sequences, including Recurrent Neural Networks, Convolutional Neural Networks, Memory Networks, and Graph Neural Networks.

Recently, Transformers have shown promising empirical results in various tasks, such as machine translation, time-series forecasting, and token-based object detection. A component of Transformers is a self-attention network, which may be highly efficient and capable of learning long-range dependencies by computing attention weights between each pair of objects in a sequence. Inspired by the success of Transformer, several self-attentive sequential recommendations have been proposed and achieved state-of-the-art performance. For example, SASRec, which is described in the paper titled “Self-attentive sequential recommendation” by Wang-Cheng Kang and Julian McAuley (2018) in ICDM′18 at 197-206 (arXiv: 1808.09781), the disclosure of which is hereby incorporated by reference in its entirety, is the pioneering framework to adopt self-attention networks to learn the importance of items at different positions. BERT4Rec, which is described in the paper titled “BERT4Rec: Sequential recommendation with bidirectional encoder representations from transformer” by Fei Sun, Jun Liu, Jian Wu, Changhua Pei, Xiao Lin, Wenwu Ou, and Peng Jiang (2019) in CIKM′19 at 1441-1450 (arXiv: 1904.06690), the disclosure of which is hereby incorporated by reference in its entirety, further models the correlations of items from both left-to-right and right-to-left directions. SSE-PT, which is described in the paper titled “SSE-PT: Sequential recommendation via personalized transformer” by Liwei Wu, Shuqing Li, Cho-Jui Hsieh, and James Sharpnack (2020) in RecSys at 328-337 ( ) the disclosure of which is hereby incorporated by reference in its entirety, is a personalized Transformer model that provides better interpretability of engagement patterns by introducing user embeddings.

Although encouraging performance has been achieved, the robustness of sequential recommendation is far less studied in the area of recommender systems. For example, there may not be any strong assumptions about how a user's historical actions should be generated in online shopping scenarios. Also, real-world item sequences are often noisy, containing both true-positive and false-positive interactions. For example, a portion of items may end up with negative reviews and/or being returned. Clearly, not every item in a sequence may be aligned well with user preferences, especially for implicit feedback. Unfortunately, the existing self-attention network is not Lipschitz continuous (e.g., a function may be Lipschitz continuous if changing its input by a certain amount will not significantly change its output, etc.), and is vulnerable to the quality of input sequences. For example, it has been found that a large amount of BERT's attentions focus on less meaningful tokens, such as “[September]” and “.”, which may lead to a misleading explanation and to sub-optimal performance if self-attention networks are not well regularized for noisy sequences.

To address these issues, a straightforward strategy is to design sparse Transformer architectures that sparsify the connections in the attention layers, which have been actively investigated in language modeling tasks. Several representative models are Star Transformer, Sparse Transformer, Longformer, and Big-Bird. These sparse attention patterns may mitigate noise issues and avoid allocating credits to unrelated content for the query of interest. However, these existing models largely rely on pre-defined attention schemes, which lack flexibility and adaptability in practice. Unlike end-to-end training approaches, whether these sparse patterns can generalize well to sequential recommendation remains unknown and is still an open research question. Another line of work addressing these issues focuses on Dropout techniques for Transformers, including LayerDrop, DropHead, and UniDrop. However, these random dropout approaches are susceptible to bias, namely: the fact that attentions can be dropped randomly does not mean that the model allows them to be dropped, which may lead to overaggressive pruning issues.

Non-limiting embodiments or aspects of the present disclosure provide methods, systems, and computer program products that improve Transformer for sequential recommendation. For example, a method according to non-limiting embodiments or aspects may receive an input sequence having a respective input at each of a plurality of input positions in an input order; process the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including: an encoder gated attention layer that is configured to receive the subnetwork input for each of the plurality of input positions and, for each particular input position in the input order: apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; process the encoded representations through a decoder neural network to generate an output sequence having a respective output at each of a plurality of output positions in an output order; and provide the output sequence having the respective output at each of the plurality of output positions in the output order.

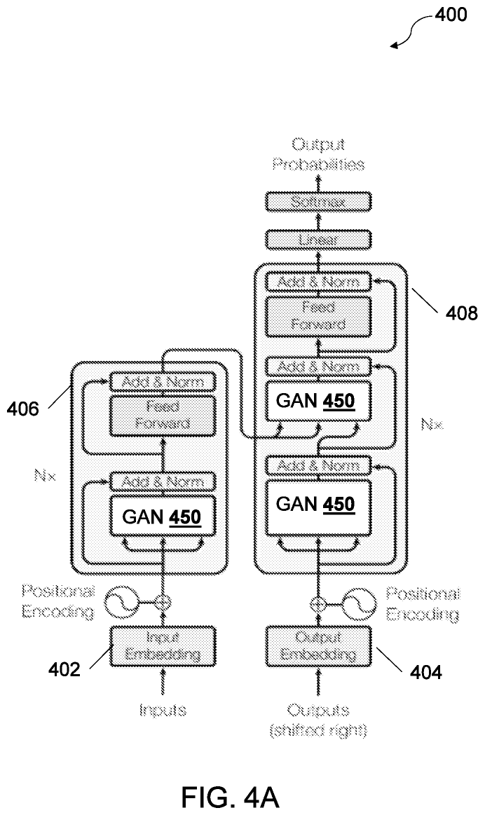

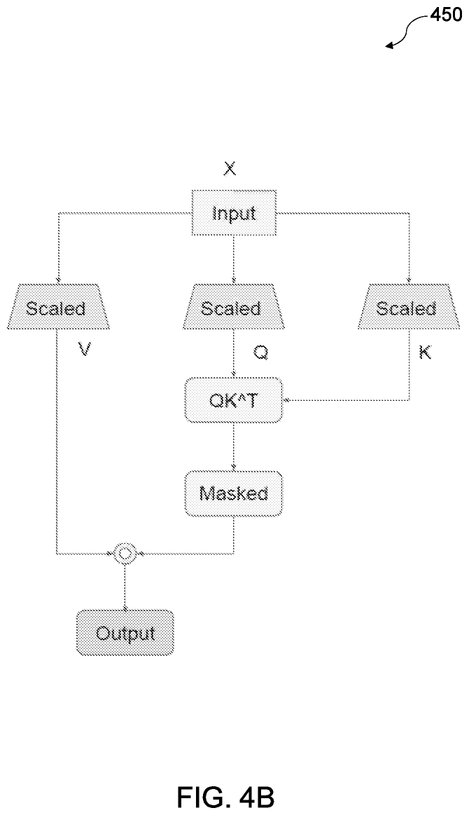

In this way, non-limiting embodiments or aspects of the present disclosure may provide a de-noising strategy (e.g., a Rec-Denoiser, etc.) for better training self-attentive sequential recommendations. For example, non-limiting embodiments or aspects recognize that not all attentions are necessary and simply pruning redundant attentions may further improve the performance. Rather than randomly dropping out attentions, non-limiting embodiments or aspects use differentiable masks to drop task-irrelevant attentions in the self-attention layers, which can yield exactly zero probability for noisy items. The introduced sparsity in attentions may have several benefits. Irrelevant attentions with parameterized masks can be learned to be dropped in a data-driven way (e.g., referring to FIGS. 4A and 4B, the Rec-de-noiser or gated attention layer (GAN) 450 may prune a sequence of items including a phone, a bag, and a headphone for a pant, and a sequence of items including a phone, a bag, a headphone, and a pant for a laptop in the attention map, etc.). For example, non-limiting embodiments or aspects may seek next item prediction explicitly based on a subset of more informative items. Further, the Rec-de-noiser or gated attention layer may still take full advantage of Transformers as the Rec-de-noiser or gated attention layer need not change the overall Transformer architecture, but only the attention distributions thereof. As such, Rec-Denoiser may be easy to implement and/or may be compatible to any Transformer, making the Transformers less complicated as well as improving the interpretability of the Transformers.

The discreteness of binary masks (e.g., 0 is dropped while 1 is kept) is, however, intractable in the back-propagation. To remedy this issue, non-limiting embodiments or aspects relax the discrete variables with a continuous approximation through probabilistic reparameterization, for example, as described in the paper titled “The concrete distribution: A continuous relaxation of discrete random variables” by Chris J Maddison, Andriy Mnih, and Yee Whye The (2017) in ICLR, the disclosure of which is hereby incorporated by reference in its entirety. Non-limiting embodiments or aspects may further provide an unbiased and low-variance gradient estimator to effectively estimate the gradients of binary variables. As such, differentiable masks of non-limiting embodiments or aspects can be trained jointly with original Transformers in an end-to-end fashion. In addition, as mentioned herein, the scaled dot-product attention is not Lipschitz continuous and is thus vulnerable to input perturbations. Accordingly, to further improve training stability, non-limiting embodiments or aspects may further apply the Jacobian regularization as described in the paper titled “Robust learning with jacobian regularization” by Judy Hoffman, Daniel A Roberts, and Sho Yaida (2019) (arXiv preprint arXiv: 1908.02729), and in the paper titled “Improving dnn robustness to adversarial attacks using jacobian regularization” by Daniel Jakubovitz and Raja Giryes (2018) in ECCV at 514-529, the disclosures of which are hereby incorporated by reference in their entirety, to the self-attention blocks, including a point-wise feed-forward layer, to improve the robustness of Transformers for noisy sequences.

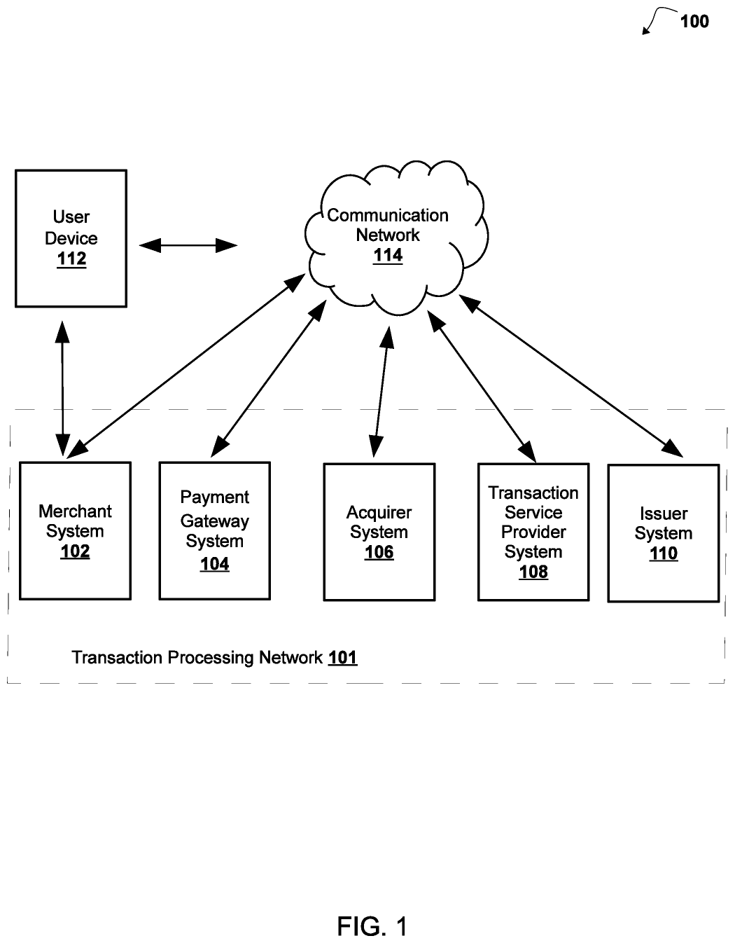

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 116. Transaction processing network 101, merchant system 102, payment gateway system 104, acquirer system 106, transaction service provider system 108, issuer system 110, and/or user device 112, may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 116, etc.) and/or communicating information and/or data to payment gateway system 104, acquirer system 106, transaction service provider system 108, issuer system 110, and/or user device 112 (e.g., via communication network 116, etc.). Merchant system 102 may include a device capable of receiving information and/or data from user device 112 via a communication connection (e.g., an NFC communication connection, an RFID communication connection, a Bluetooth® communication connection, etc.) with user device 112 and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 116, etc.) and/or communicating information and/or data to merchant system 102, acquirer system 106, transaction service provider system 108, issuer system 110, and/or user device 112 (e.g., via communication network 116, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 116, etc.) and/or communicating information and/or data to merchant system 102, payment gateway system 104, transaction service provider system 108, issuer system 110, and/or user device 112 (e.g., via communication network 116, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 116, etc.) and/or communicating information and/or data to merchant system 102, payment gateway system 104, acquirer system 106, issuer system 110, and/or user device 112 (e.g., via communication network 116, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 (e.g., via communication network 116, etc.) and/or communicating information and/or data to merchant system 102, payment gateway system 104, acquirer system 106, transaction service provider system 108, and/or user device 112 (e.g., via communication network 116 etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 116, etc.) and/or communicating information and/or data to merchant system 102, payment gateway system 104, acquirer system 106, transaction service provider system 108, and/or issuer system 110 (e.g., via communication network 116, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, an issuer bank application, and/or the like) stored and/or executed on user device 112. In some non-limiting embodiments or aspects, user device 112 may be associated with a sender account and/or a receiving account in a payment network for one or more transactions in the payment network.

Communication network 116 may include one or more wired and/or wireless networks. For example, communication network 116 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

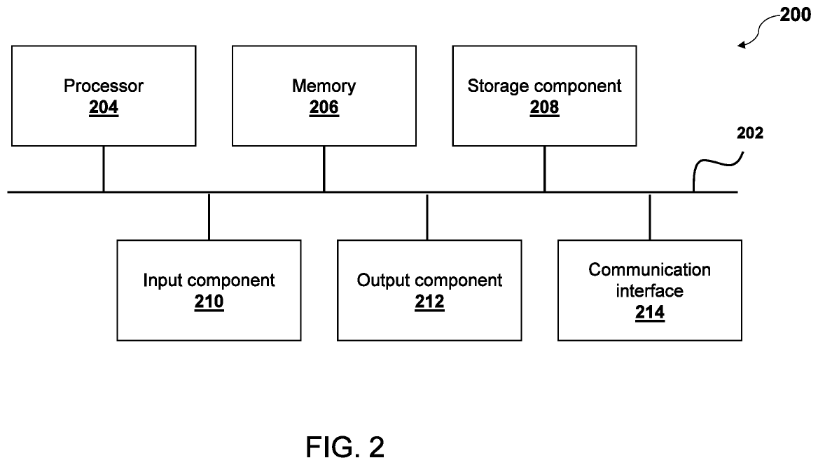

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 (e.g., a central processing unit (CPU), a graphics processing unit (GPU), etc.) executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

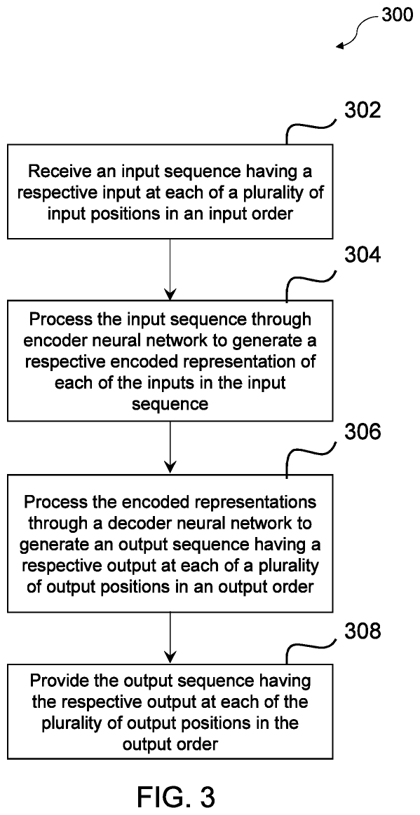

Referring now to FIG. 3, FIG. 3 is a flowchart of non-limiting embodiments or aspects of a process 300 for maintaining model state. In some non-limiting embodiments or aspects, one or more of the steps of process 300 may be performed (e.g., completely, partially, etc.) by transaction service provider system 108 (e.g., one or more devices of transaction service provider system 108, etc.). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 3, at step 302, process 300 includes receiving an input sequence having a respective input at each of a plurality of input positions in an input order. For example, transaction service provider system 108 may receive an input sequence having a respective input at each of a plurality of input positions in an input order. As an example, for sequential recommendation tasks, letting U be a set of users, V a set of items, and S=(S¹, S², . . . , S^{|u|}) a collection of users' actions, each user u∈U may be associated with a sequence of items S^{u}=(S₁^{u}, S₂^{u}, . . . , S_{|S}^{u}_{|}^{u}), in a chronological order, where |S^{u}| is the length, and sₜ^{u} ∈V is the item that user u has interacted with at time t. In such an example, transaction service provider system 108 may receive s^{u}=(S₁^{u}, S₂^{u}, . . . , S_{|S}^{u}_{|}^{u}) as the input sequence having the respective input at each of the plurality of input positions in the input order.

The sequential recommendation may be evaluated as a next item prediction. For example, for each user u, transaction service provider system 108 may seek to predict a next item S_{|}^{u+1}_{|}^{u}, at time step |S″+1| based on the interaction history S^{u} as described herein in more detail.

An item may include any type of item, such as a clothing item, an electronic item, a video game item, a movie item, an image item, a word or text item, and/or the like. A user interaction with an item may include any type of action by the user with the item, such as a review of the item by the user, a use of the item by the user (e.g., a click on an item representation in a webpage by the user, a download of a digital item by the user, a playback of a movie by the user, etc.), and/or the like.

As shown in FIG. 3, at step 304, process 300 includes processing the input sequence through an encoder neural network to generate a respective encoded representation of each of the inputs in the input sequence. For example, transaction service provider system 108 may process the input sequence through an encoder neural network to generate a respective encoded representation of each of the inputs in the input sequence.

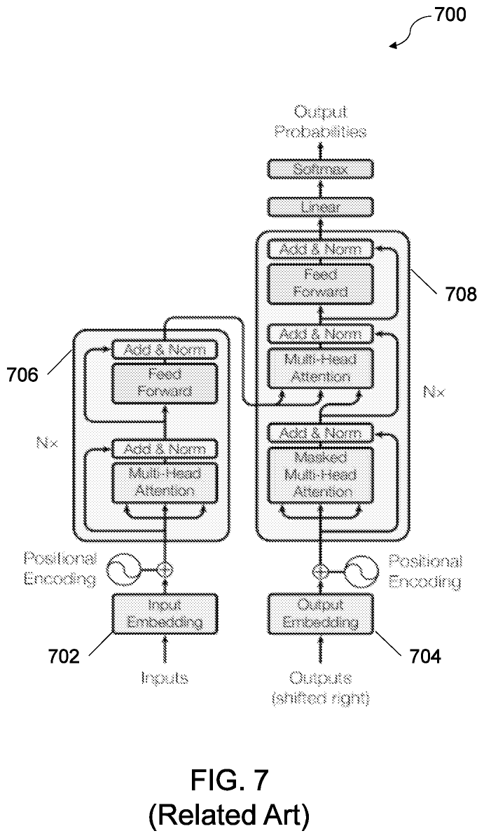

As previously described herein, due to efficient parallel training, Transformers have been widely used in sequential recommendations, such as SASRec, BERT4Rec, TiSASRec, and Transformers4Rec. Referring also to FIG. 7, which is a diagram of a model architecture of an existing Transformer 700, an Embedding Layer (e.g., input embedding 702, output embedding 704, etc.), a Transformer Module (e.g., encoder 706, decoder 708, etc.), and Optimization of existing Transformer 700 is now described herein.

Transformer-based recommenders may maintain an item embedding table M∈ [symbol] ^{|V|×d}, where d is the size of the embedding. For each sequence S^{u}, the item embedding table can be converted into a fixed sequence (s₁, S₂, . . . , Sₙ), where n is the maximum length (e.g., keeping the most recent n items by truncating or padding items, etc.). The embedding for (S₁, S₂, . . . , Sₙ) may be denoted as E∈ [symbol] ^{n×d}, which can be retrieved from the embedding table M.

To preserve the time order of item sequence, a learnable positional embedding P∈ [symbol] ^{n×d} may be further constructed. The item embedding and the positional embedding may be added up as X=E+P. The composited embedding X∈ [symbol] ^{n×d} can be directly fed to any Transformer-based recommender.

On the top of the embedding layer there is a Transformer module that includes a self-attention layer and a point-wise feed-forward layer. For example, the Transformer may have an encoder-decoder structure. Encoder 706 may map an input sequence of symbol representations to a sequence of continuous representations. Given a continuous representation, decoder 708 generates an output sequence of symbols one element at a time. At each step the model is auto-regressive, consuming the previously generated symbols as additional input when generating the next. Existing Transformer 700 follows this overall architecture using stacked self-attention and point-wise, fully-connected layers for both the encoder 706 and the decoder 708, shown in the left and right halves of FIG. 7, respectively.

For example, encoder 706 may be composed of a stack of N (e.g., N=6, etc.) identical layers. Each layer may have two sub-layers. The first may be a multi-head self-attention mechanism, and the second is may be simple, position-wise fully connected feed-forward network. A residual connection may be employed around each of the two sub-layers, followed by layer normalization. That is, the output of each sub-layer may be LayerNorm (x+Sublayer (x)), where Sublayer (x) is the function implemented by the sub-layer itself. To facilitate these residual connections, all sub-layers in the model, as well as the embedding layers, may produce outputs of a same dimension (e.g., 512, etc.).

For example, decoder 708 may be composed of a stack of N (e.g., N=6, etc.) identical layers. In addition to the two sub-layers in each encoder layer, the decoder 708 may insert a third sub-layer, which performs multi-head attention over the output of the encoder stack. Similar to the encoder, the decoder 708 may employ residual connections around each of the sub-layers, followed by layer normalization. The self-attention sub-layer in the decoder stack may be modified to prevent positions from attending to subsequent positions. This masking, combined with fact that the output embeddings are offset by one position, ensures that the predictions for a position in the input sequence can depend only on the known outputs at positions less than that position.

The self-attention layer may learn long-range dependencies within a sequence. The scaled dot-product attention may be defined according to the following Equation (1):

$$H = softmax ( \frac{{QK}^{T}}{\sqrt{d}} ) V \qquad ( 1 )$$

where H∈ [symbol] ^{n×d} is the output item representations; Q=XW^{Q}, K=XW^{K}, and V=XW^{V} are the queries, keys, and values, respectively; {W^{Q}, w^{K}, w^{V}}∈ [symbol] ^{n×d} are three projection matrices; and \sqrt{d} is the scale factor. In practice, multi-head self-attention layers and point-wise feed-forward layers may be adopted to better capture item dependencies. In the interest of brevity, the details of the multi-head self-attention layers and the point-wise feed-forward layers are omitted herein and the Transformer module or block of existing Transformer 700 is summarized as: H⁽¹⁾←Transformer (H⁽¹⁻¹⁾), with H⁽⁰⁾=X, because the multi-head self-attention layers and the point-wise feed-forward layers have been previously described in the paper titled “Self-attentive sequential recommendation” by Wang-Cheng Kang and Julian McAuley (2018) in ICDM at 197-206, and in the paper titled “Attention is all you need” by Ashish Vaswani, Noam Shazeer, Niki Parmar, Jakob Uszkoreit, Llion Jones, Aidan N Gomez, Łukasz Kaiser, and Illia Polosukhin (2017) in NeurIPS at 5998-6008, the disclosures of which are hereby incorporated by reference in their entirety.

After stacked L Transformer blocks, the next item (given the first t items) may be based on Hₜ^{(L)} For example, an inner product may be used to predict users' preference score of item i according to the following Equation (2):

$${r}_{i , t} = 〈 {H}_{t}^{( L )} , {M}_{i} 〉 \qquad ( 2 )$$

where Mᵢ ∈ [symbol] ^{d} is the embedding of item i. Transformer may feed a sequence s=(S₁, S₂, . . . , Sₙ) and its desired output may be a shifted version of the same sequence o=(O₁, O₂, . . . , Oₙ), and the binary cross-entropy loss may be used as a learning objective according to the following Equation (3):

$$ℒ ( θ ) = {\sum }_{{s}^{u} ∈ S} {\sum }_{t = 1}^{n} [ log ( σ ( {r}_{{o}_{t}} , t ) ) ) + log ( 1 - σ ( {r}_{{o}_{t}^{′}} , t ) ) ] \qquad ( 3 )$$

where θ is the model parameters, of o′ₜ ∉S^{u} is a negative sample corresponding to oₜ and σ(·) is the sigmoid function.

A Gated Attention Network (GAN) according to non-limiting embodiments or aspects may provide a simpler yet more efficient layer than existing Transformer 700. Although GAN may have quadratic complexity over the sequence length, GAN may be more desirable for detecting a noisy sequence. For example, and referring also to FIG. 4A, which is a diagram of a model architecture of non-limiting embodiments or aspects of Transformer 400, Transformer 400 may include an embedding layer (e.g., input embedding 402, output embedding 404, etc.), encoder 406, and/or decoder 408. As an example, Transformer 400 may include a sequence transduction neural network for transducing an input sequence having a respective network input at each of a plurality of input positions in an input order into an output sequence having a respective network output at each of a plurality of output positions in an output order. In such an example, the multi-head attention of existing Transformer 700 in encoder 706 and decoder 708 may be replaced with GAN 450 in encoder 406 and decoder 408 of Transformer 400. It is noted that unless otherwise described herein, an architecture and function of Transformer 400 may be the same as or similar to an architecture and function of existing Transformer 700; therefore, same or similar elements or functions of Transformer 400 previously described herein with respect to existing Transformer 700 may be omitted in the interest of brevity.

Encoder 406 (e.g., the encoder neural network, etc.) may comprise a sequence of one or more encoder subnetworks. Each encoder subnetwork may be configured to receive a respective encoder subnetwork input for each of the plurality of input positions and to generate a respective encoder subnetwork output for each of the plurality of input positions. For example, Encoder 406 may be composed of a stack of N (e.g., N=6, etc.) identical encoder subnetworks or layers. Each layer may have two sub-layers. The first may be GAN 450, and the second is may be simple, position-wise fully connected feed-forward network. A residual connection may be employed around each of the two sub-layers, followed by layer normalization. That is, the output of each sub-layer may be LayerNorm (x+Sublayer (x)), where Sublayer (x) is the function implemented by the sub-layer itself. To facilitate these residual connections, all sub-layers in the model, as well as the embedding layers, may produce outputs of a same dimension (e.g., 512, etc.).

Referring also to FIG. 4B, which is a diagram of a model architecture of GAN 450, each encoder subnetwork may include an encoder gated attention layer (e.g., GAN 450, etc.) that is configured to receive the subnetwork input for each of the plurality of input positions and, for each particular input position in the input order: apply a gated attention mechanism over the encoder subnetwork inputs at the plurality of input positions to generate a respective output for the particular input position. The application of a gated attention mechanism may include: determining a shared representation Z from the encoder subnetwork inputs at the plurality of input positions, determining a query Q for the particular input position from the shared representation, determining keys K for the plurality of input positions from the shared representation, determining values V for the plurality of input positions from the shared representation, and using the determined query, keys, and values to generate the respective output for the particular input position.

The shared representation Z may be determined by applying a trainable variable to the encoder subnetwork inputs at the plurality of input positions. The query Q for the particular input position may be determined by applying a query transformation to the shared representation Z. The keys K for the plurality of input positions may be determined by applying a key transformation to the shared representation Z. The values V for the plurality of input positions may be determined by applying a value transformation to the shared representation Z.

GAN 450 may generate the respective output for the particular input position by (i) determining a respective compatibility output for the particular input position by applying a compatibility function between the query Q for the particular input position and the keys K generated for the plurality of input positions and (ii) applying a learned variance M to the compatibility output for the particular input position to generate a respective attention value A for the particular input position. GAN 450 may generate the respective output for the particular input position by applying a rectified linear unit (ReLU) activation function to the respective attention value A for the particular input position and the values for the plurality of input positions.

For example, given the input X, GAN 450 according to non-limiting embodiments or aspects may be defined according to the following Equation (4):

$$Z = {ϕ}_{z} ( XW ) , \\ Q = {S}_{q} ( Z ) , K = {S}_{k} ( Z ) , V = {S}_{v} ( Z ) , \\ A = ( {QK}^{T} ) ⊙ M , \\ H = ReLU ( A ) V \qquad ( 4 )$$

where Z is a shared representation (s<<d)³, S_{q}(·) and Sₖ(·) and Sᵥ(·) are cheap transformations that apply per-dim scalars and offsets to Z (e.g., similar to the learnable variables in LayerNorms, etc.), M is a learnable variance (e.g., a trainable variable, etc.) that can be used to sparsify the attention maps, Q, K, V, and A are the queries, keys, values, and attentions, respectively, and the softmax in existing Transformer 700 is simplified as a ReLU activation function in Transformer 400 according to non-limiting embodiments or aspects.

Each encoder subnetwork may trained according to an objective function that depends on the learned variance M and a desired attention capacity K. For example, a problem of training sparse neural networks may be naturally formulated into the following empirical risk minimization problem defined according to the following Equation (5):

$$\begin{matrix}min \\ θ , M\end{matrix} ℒ ( θ , M ) \\ s . t . {‖ M ‖}_{1} \leq K and M ∈ {\{ 0 , 1 \}}^{n \times x} \qquad ( 5 )$$

where K is the attention capacity to be pruned. In this framework, the sparse attention may be controlled by a single constraint which avoids tuning the pruning rate for each layer.

Each component of the learned variable or mask M may be viewed as a binary random variable and the risk minimization problem defined according to Equation (5) may be reparametrized with respect to the distributions of this random variable, and the risk minimization problem defined according to Equation (5) may be relaxed into an excepted loss minimization problem over the weight and probability spaces, which is continuous. The relaxation may be a very tight relaxation.

Mᵢⱼ may be viewed as a Bernoulli random variable with probability sᵢⱼ to be 1 and 1−Sᵢⱼ, e.g., Mᵢⱼ˜Bern (sᵢⱼ), where sᵢⱼ ∈[0, 1]. Assuming the variables Mᵢⱼ are independent, the distribution function of M may be p(M|s)=Πᵢⱼ (Sᵢⱼ) Mᵢⱼ (1−Sᵢⱼ) (1−Mᵢⱼ). The model size may be controller by the sum of the probabilities sᵢⱼ (e.g., 1^{T}s, etc.) because [symbol] _{M-p(M|s)}∥M∥₀=Σ_{i,j} Sᵢⱼ. The discrete constraint ∥M∥₁≤K may be transformed into 1^{T}s≤K with each sᵢⱼ ∈[0, 1], which is continuous and convex. In this way, the risk minimization problem defined according to Equation (5) may be relaxed into an excepted loss minimization problem defined according to the following Equation (6):

$$\begin{matrix}min \\ θ , s\end{matrix} {𝔼}_{ρ ( M \vert s )} ℒ ( θ , M ) \\ s . t . {1}^{⊤} s \leq K and s ∈ {[ 0 , 1 ]}^{n} . \qquad ( 6 )$$

The excepted loss minimization problem defined according to Equation (6) may be solved using Projected Gradient Descent. The difficulty lies in computing the gradient of the expected loss with respect to the probability. Non-limiting embodiments or aspects of the present disclosure may use the Gumbel Softmax trick as described in the paper titled “Categorical Reparameterization with Gumbel-Softmax” by Eric Jang, Shixiang Gu, and Ben Poole (2017) in ICLR, the disclosure of which is hereby incorporated by reference in its entirety, to calculate the gradient, with which the gradient with respect to weights and probability can be calculated according to the following Equation (7):

$$\begin{matrix}{∇}_{s , Θ} {𝔼}_{p ( m \vert s )} ℒ ( Θ , m ) = {𝔼}_{{g}_{0} , {g}_{1}} {∇}_{s , Θ} ℒ ( Θ , 𝕀 ( log ( \frac{s}{1 - s} ) + {g}_{1} - {g}_{0} \geq 0 ) ) \\ \approx {𝔼}_{{g}_{0} , {g}_{1}} {∇}_{s , Θ} ℒ ( Θ , σ ( \frac{log ( \frac{s}{1 - s} ) + {g}_{1} - {g}_{0}}{τ} ) ) \\ \approx \frac{1}{I} {\sum }_{i = 1}^{I} {∇}_{s , Θ} ℒ ( Θ , σ ( \frac{log ( \frac{s}{1 - s} ) + {g}_{1}^{( i )} - {g}_{0}^{( i )}}{τ} ) )\end{matrix} \qquad ( 7 )$$

where [symbol] (A)∈{0, 1}ⁿ is the indicator function; g₀ and g₁ are two random variables, with each element independent and identically distributed (i.i.d) sampled from Gumbel (0, 1) distribution; g₁⁽ⁱ⁾ and g₀⁽ⁱ⁾ with i=1, 2, . . . , I are 2I sampled instances; σ(·): [symbol] ^{n×n}→(0, 1)^{n×n} is the element-wise sigmoid function (e.g.,

$$σ ( x ) = \frac{1}{1 + {e}^{- x}}$$

for any x∈ [symbol] ^{n×n}, etc.);

and t is a temperature annealing parameter decreasing linearly during training, wherein precise choice of the decreasing function contributes to convergence of probability to a deterministic state.

As shown in FIG. 3, at step 306, process 300 includes processing the encoded representations through a decoder neural network to generate an output sequence having a respective output at each of a plurality of output positions in an output order. For example, transaction service provider system 108 may process the encoded representations through a decoder neural network to generate an output sequence having a respective output at each of a plurality of output positions in an output order.

Decoder 408 (e.g., the decoder neural network, etc.) may be composed of a stack of N (e.g., N=6, etc.) identical decoder subnetworks or layers. Each layer may have three sub-layers. The first sub-layer may include GAN 450, and the last sub-layer may include a simple, position-wise fully connected feed-forward network. In addition to these two sub-layers, decoder 408 may insert a third sub-layer there between, which applies GAN 450 over the output of the encoder stack. Similar to encoder 406, decoder 408 may employ residual connections around each of the sub-layers, followed by layer normalization. The self-attention sub-layer in the decoder stack may be modified to prevent positions from attending to subsequent positions. This masking, combined with fact that the output embeddings are offset by one position, ensures that the predictions for a position in the input sequence can depend only on the known outputs at positions less than that position.

For example, decoder 408 (e.g., the decoder neural network, etc.) may include a sequence of one or more decoder subnetworks, each decoder subnetwork configured to receive a shifted version (e.g., shifted right one position, etc.) of the output sequence having the respective output at each of the plurality of output positions in the output order and to generate a respective decoder subnetwork output for each of the plurality of output positions. Decoder 408 may include multiple GANs 450. A first GAN 450 may be configured to receive the shifted version (e.g., shifted right one position, etc.) of the output sequence having the respective output at each of the plurality of output positions in the output order and, for each particular output position in the output order: apply the gated attention mechanism over the shifted outputs at the plurality of output positions to generate a respective sublayer output for the particular output position, wherein applying the gated attention mechanism comprises: determining a shared representation from the shifted outputs at the plurality of output positions, determining a query for the particular output position from the shared representation, determining keys for the plurality of output positions from the shared representation, determining values for the plurality of output positions from the shared representation, and using the determined query, keys, and values to generate the respective output for the particular output position.

A second GAN 450 may be configured to receive the respective sublayer output for the particular output position from the first GAN 450 and the respective encoded representation of each of the inputs in the input sequence. For example, the second GAN 450 may, for each particular output position in the output order: apply the gated attention mechanism over the respective sublayer output for the particular output position from the first GAN 450 and/or the respective encoded representation of each of the inputs in the input sequence, wherein applying the gated attention mechanism comprises: determining a shared representation from the respective sublayer output for the particular output position from the first GAN 450 and/or the respective encoded representation of each of the inputs in the input sequence, determining a query for the particular output position from the shared representation, determining keys for the plurality of output positions from the shared representation, determining values for the plurality of output positions from the shared representation, and using the determined query, keys, and values to generate the respective output for the particular output position.

As shown in FIG. 3, at step 308, process 300 includes providing the output sequence having the respective output at each of the plurality of output positions in the output order. For example, transaction service provider system 108 may provide (e.g., output, display, etc.) the output sequence having the respective output at each of the plurality of output positions in the output order. As an example, transaction service provider system 108 may for each user u, provide a next item S_{|u}⁺¹_{|}^{u}, at time step |S^{u}+1| based on the interaction history S^{u}. In such an example, the next item may be provided to the user as a recommendation to the user (e.g., as a recommended product or service to purchase, etc.).

### EXAMPLE EXPERIMENTS

An experimental setup and empirical results are provided for experiments designed to answer the following research questions: Does de-noising Transformer works better than Transformer.

A simplified Transformer according to non-limiting embodiments or aspects is evaluated on four datasets from three real world applications. The datasets vary significantly in domains, platforms, and sparsity:—Amazon: A series of datasets, comprising large corpora of product reviews crawled from Amazon.com. Top-level product categories on Amazon are treated as separate datasets. The Experiments consider two categories, ‘Beauty,’ and ‘Games.’ This dataset is notable for its high sparsity and variability.—Steam: We introduce a new dataset crawled from Steam, a large online video game distribution platform. The dataset contains 2, 567, 538 users, 15,474 games and 7,793,069 English reviews spanning October 2010 to January 2018. The dataset also includes rich information, like users' play hours, pricing information, media score, category, developer (etc.).—MovieLens: A widely used benchmark dataset for evaluating collaborative filtering algorithms. The Experiments use the version (MovieLens-1M) that includes 1 million user ratings.

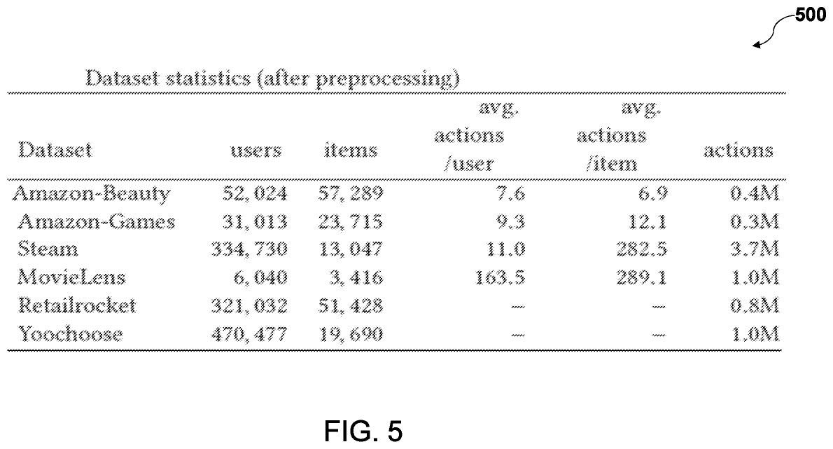

The Experiments follow the same preprocessing procedure as described in the paper titled “Reducing Transformer Depth on Demand with Structured Dropout” by Angela Fan, Edouard Grave, and Armand Joulin (2020) in ICLR, and the paper titled “Improving dnn robustness to adversarial attacks using jacobian regularization” by Daniel Jakubovitz and Raja Giryes (2018) in ECCV at 514-529, the disclosures of which are hereby incorporated by reference in their entirety. For each the datasets, the Experiments treat the presence of a review or rating as implicit feedback (e.g., the user interacted with the item, etc.) and use timestamps to determine the sequence order of actions. The Experiments discard users and items with fewer than 5 related actions. For partitioning, the Experiments split the historical sequence S^{u} for each user u into three parts: (1) the most recent action |Su| for testing, (2) the second most recent action |Su|1 for validation, and (3) all remaining actions for training. Note that during testing, the input sequences contain training actions and the validation action. The data statistics are listed in table 500 shown in FIG. 5.

The baseline for the Experiments may be the Transformer as described in the paper titled “Time interval aware self-attention for sequential recommendation” by Jiacheng Li, Yujie Wang, and Julian McAuley (2020) in WSDM at 322-330, the disclosure of which is hereby incorporated by reference in its entirety, and which is a backbone framework that many of state-of-the-art algorithms are built on.

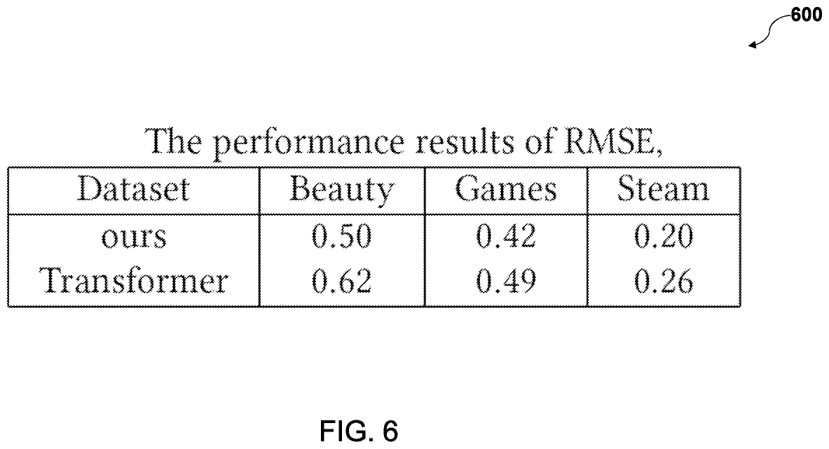

Root mean square error (RSME) may be used to evaluate a simplified Transformer according to non-limiting embodiments or aspects. To avoid heavy computation on all user-item pairs, the Experiments followed the strategy in the paper titled “Time interval aware self-attention for sequential recommendation” by Jiacheng Li, Yujie Wang, and Julian McAuley (2020) in WSDM at 322-330. For each user u, the Experiments randomly sampled 100 negative items, and ranked these items with the ground truth item. Based on the rankings of these 101 items, RSME was evaluated. As shown in table 600 in FIG. 6, a simplified Transformer according to non-limiting embodiments or aspects is better than the existing Transformer.

Accordingly, non-limiting embodiments or aspects of the present disclosure may provide methods, systems, and/or computer program products that address weaknesses in Transformers in handling noisy sequences by providing a simple layer named gated attention layer, which enables the use of a weaker single-head attention with minimal quality loss, and by using a probabilistic sparsification framework to further prune noise and achieve sparse attention in high quality.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method, comprising:
receiving an input sequence having a respective input at each of a plurality of input positions in an input order;
processing the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including:
an encoder gated attention layer that is configured to receive the subnetwork input for each of the plurality of input positions and, for each particular input position in the input order:
apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; and
processing the encoded representations through a decoder neural network to generate an output sequence having a respective output at each of a plurality of output positions in an output order; and
providing the output sequence having the respective output at each of the plurality of output positions in the output order.

2. The method of claim 1, wherein the shared representation is determined by applying a trainable variable to the encoder subnetwork inputs at the plurality of input positions.

3. The method of claim 1, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

4. The method of claim 1, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

5. The method of claim 4, wherein the gated attention layer generates the respective output for the particular input position by applying a rectified linear unit (ReLU) activation function to the respective attention value for the particular input position and the values for the plurality of input positions.

6. The method of claim 4, wherein each encoder subnetwork is trained according to an objective function that depends on the learned variance and a desired attention capacity.

7. A system comprising one or more computers and one or more storage devices storing instructions that when executed by the one or more computers cause the one or more computers to implement a sequence transduction neural network for transducing an input sequence having a respective network input at each of a plurality of input positions in an input order into an output sequence having a respective network output at each of a plurality of output positions in an output order, the sequence transduction neural network comprising:
an encoder neural network configured to receive the input sequence and generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including:
an encoder gated attention layer that is configured to receive the subnetwork input for each of the plurality of input positions and, for each particular input position in the input order:
apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; and
a decoder neural network configured to receive the encoded representations and generate the output sequence.

8. The system of claim 7, wherein the shared representation is determined by applying a trainable variable to the encoder subnetwork inputs at the plurality of input positions.

9. The system of claim 7, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

10. The system of claim 7, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

11. The system of claim 10, wherein the gated attention layer generates the respective output for the particular input position by applying a rectified linear unit (ReLU) activation function to the respective attention value for the particular input position and the values for the plurality of input positions.

12. The system of claim 10, wherein each encoder subnetwork is trained according to an objective function that depends on the learned variance and a desired attention capacity.

13. A computer program product including a non-transitory computer readable medium including program instructions which, when executed by at least one processor, cause the at least one processor to:
receive an input sequence having a respective input at each of a plurality of input positions in an input order;
process the input sequence through an encoder neural network to generate a respective encoded representation of each of the inputs in the input sequence, the encoder neural network comprising a sequence of one or more encoder subnetworks, each encoder subnetwork configured to receive a respective encoder subnetwork input for each of the plurality of input positions and to generate a respective encoder subnetwork output for each of the plurality of input positions, and each encoder subnetwork including:
an encoder gated attention layer that is configured to receive the subnetwork input for each of the plurality of input positions and, for each particular input position in the input order:
apply a gated attention mechanism over the encoder subnetwork inputs at the plurality of input positions to generate a respective output for the particular input position, wherein applying a gated attention mechanism comprises: determining a shared representation from the encoder subnetwork inputs at the plurality of input positions, determining a query for the particular input position from the shared representation, determining keys for the plurality of input positions from the shared representation, determining values for the plurality of input positions from the shared representation, and using the determined query, keys, and values to generate the respective output for the particular input position; and
process the encoded representations through a decoder neural network to generate an output sequence having a respective output at each of a plurality of output positions in an output order; and
provide the output sequence having the respective output at each of the plurality of output positions in the output order.

14. The computer program product of claim 13, wherein the shared representation is determined by applying a trainable variable to the encoder subnetwork inputs at the plurality of input positions.

15. The computer program product of claim 13, wherein the query for the particular input position is determined by applying a query transformation to the shared representation, wherein the keys for the plurality of input positions are determined by applying a key transformation to the shared representation, and wherein the values for the plurality of input positions are determined by applying a value transformation to the shared representation.

16. The computer program product of claim 13, wherein the gated attention layer generates the respective output for the particular input position by (i) determining a respective compatibility output for the particular input position by applying a compatibility function between the query for the particular input position and the keys generated for the plurality of input positions and (ii) applying a learned variance to the compatibility output for the particular input position to generate a respective attention value for the particular input position.

17. The computer program product of claim 16, wherein the gated attention layer generates the respective output for the particular input position by applying a rectified linear unit (ReLU) activation function to the respective attention value for the particular input position and the values for the plurality of input positions.

18. The computer program product of claim 16, wherein each encoder subnetwork is trained according to an objective function that depends on the learned variance and a desired attention capacity.
